(19) United States
(12) Patent Application Publication
(10) Pub. No.: US 2011/0036130 A1
(43) Pub. Date: Feb. 17, 2011

(54) CATALYTIC CONVERTER THEFT DETERRENT DEVICE

(76) Inventor: Karla Jean Hisler, Bellevue, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/542,283

(22) Filed: Aug. 17, 2009

(51) Int. Cl. E05B 45/06; E05B 65/00

(52) U.S. Cl. 70/57.1; 70/273

(57) ABSTRACT

A catalytic converter theft deterrent assembly (100) used with a motor vehicle includes a plurality of clamps (109) for attaching to a section of exhaust pipe (101) used with a catalytic converter (105). One or more wire ropes (113) may be fixedly attached to the plurality of clamps (109) for surrounding portions around the perimeter of the exhaust pipe (101). A plurality of collars (111) are fixedly attached to the plurality of clamps (109) for housing an end portion of the plurality of cables (113) such that the cables prevent removal of the exhaust pipe (101) connected to the catalytic converter (105) for deterring theft.

### FIELD OF THE INVENTION

The present invention relates generally to theft deterrent devices and more particularly to theft deterrent devices used with automotive catalytic converters.

### BACKGROUND OF THE INVENTION

A catalytic converter (also known as a “cat” or “cat-con”), is a device used to reduce the toxicity of emissions from an internal combustion engine. Catalytic converters were initially introduced in the mid 1970s on series-production automobiles in the U.S. market. The catalytic converter was introduced to comply with regulations from the Environmental Protection Agency (EPA) to reduce emissions from a vehicle's exhaust system. More specifically, the catalytic converter provides an environment for a chemical reaction wherein toxic combustion by-products are converted to less-toxic substances.

Seen in prior art FIG. 1, the catalytic converter is generally mounted downstream of a vehicle exhaust manifold and before the muffler. In vehicles using a duel exhaust, separate catalytic converters can be used for separate exhaust pipes or each “bank” of exhaust that can be channeled through a single catalytic converter.

Each catalytic converter is comprised of box-like housing that is sized to fit under a vehicle. The interior of the catalytic converter often includes various chambers or compartments that includes various chemical solids or metallic components. In operation, exhaust gasses propagate through these chambers as the gasses undergo a chemical reaction for filtering and removing impurities. Left untreated, these impurities can harm the environment.

In that the price of raw materials, such as scrap metal, has maintained a high price, it is commonplace for thieves to clandestinely move under a parked vehicle to remove the catalytic converter when the owner is unaware or not paying attention to the vehicle. This is most often accomplished using a portable, battery-operated reciprocating saw (also referred to as a Sawzawl) where the exhaust pipes at both ends of the converter are cut allowing the converter to drop free and be quickly removed.

One type of theft deterrent device for combating this problem is a cage-like device using cables for surrounding the catalytic converter. Although this type of device may help prevent thieves from cutting through the catalytic converter, it does not prevent or deter the most typical type of theft, where cuts are made in the exhaust pipes at both ends of the converter.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is diagram illustrating how the catalytic converter theft deterrent device is fastened to the exhaust pipes leading to and from the catalytic converter.

FIG. 2 is perspective view of a clamp used in connection with the theft deterrent device of an embodiment of the present invention.

FIG. 3 is a perspective view of a clamp having an alarm wire used in connection with an alternative embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE PREFERRED EMBODIMENTS

Before describing in detail embodiments that are in accordance with the present invention, it should be observed that the embodiments reside primarily in combinations of method steps and apparatus components related to a device for protecting a vehicular catalytic converter against theft. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

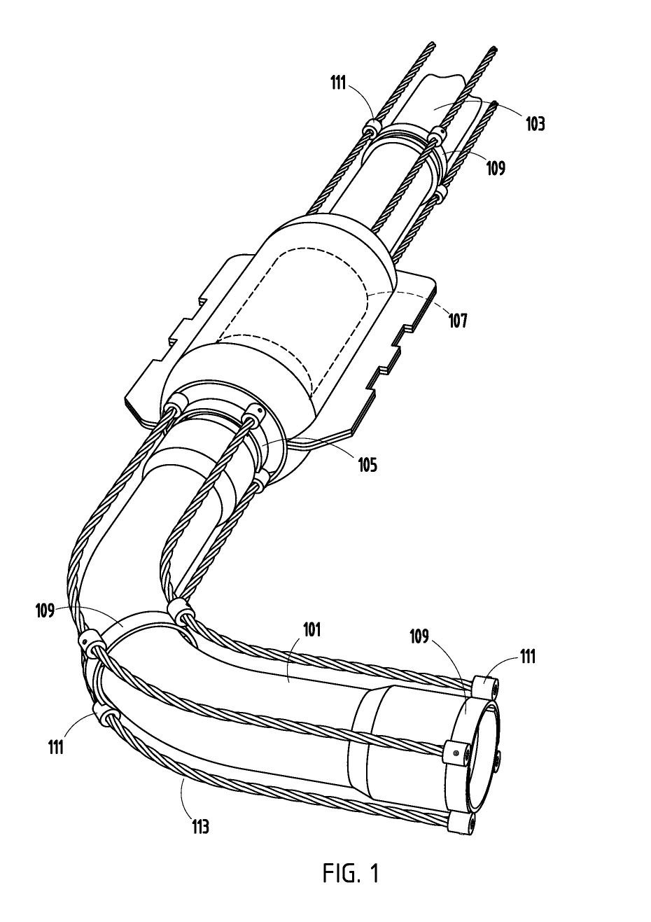

FIG. 1 is a perspective view of the catalytic converter theft deterrent device in accordance with an embodiment of the invention. The catalytic converter theft deterrent device 100 is used in connection with the series of exhaust pipes, such as inlet exhaust pipes 101 and outlet exhaust pipes 103. The inlet exhaust pipe 101 typically feeds the catalytic converter 105 from the engine exhaust manifold and may also include a cover or heat shield 107. As seen in FIG. 1, the catalytic converter theft deterrent device 100 operates by forming a barrier using a plurality of cables over the inlet and/or outlet exhaust pipes for preventing a saw or torch from easily cutting through the hollow exhaust pipe tubing.

The catalytic converter theft deterrent device 100 further includes one or more clamps 109 manufactured of hardened steel that include a plurality of collars 111 that surround the clamp 109. The collars 111 are also sometimes referred to as “swage buttons” and are typically made of a hardened stainless steel to prevent rust and corrosion while under a vehicle. The collars 111 act as a housing for a plurality of wire rope sections or cables 113 that are engaged within the collar 111 and work to securely fasten the cable therein. Although FIG. 1 is shown using four collars 111 surrounding each of the clamps 109, it will be evident to those skilled in the art that a greater or lesser number of cables 113 can be used to surround the perimeter of the input exhaust 101.

In operation, the clamps 109 are aligned for allowing a corresponding cable 113 to be secured within a collar 111 around the perimeter of the input exhaust pipe 101. Each cable 113 is fastened within the corresponding collar 111 through the use of a mechanical fastener and/or weld so that the cable cannot be easily moved within the collar 111. Although the frame of the collar 111 is shown having a substantially semi-circular circumference it should be evident to those skilled in the art that the frame my also be a square or triangular shape for matching cable shape. Moreover, the frame may also include a split body allowing two or more cables to extend through the frame of the swage button 111. In use, this arrangement not only works to prevent each of the cables 113 from being rotated around the exhaust pipe 101, but also allows the cables to be secured in a rigid position for preventing a saw blade or the like from easily cutting through the cables 113. By way of example, the cables 113 are like those manufactured by the Wire Rope Corporation of America, Inc., and may be typically made of a stranded Stainless Steel RRW.410D, ⅜ inch (9.5 mm) wire rope material that can handle forces in tension up to 12,000 lbs.

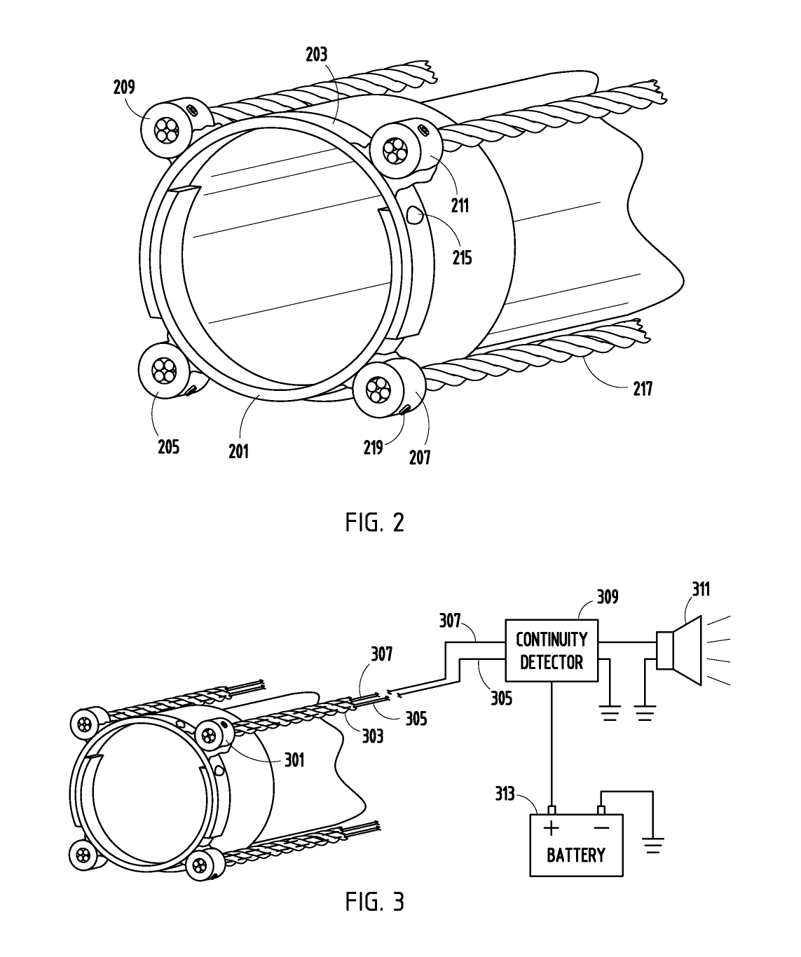

FIG. 2 is a perspective view of the clamp for holding a cable as shown in FIG. 1. In this embodiment, the clamp 200 includes a greater plurality of collars which surround the perimeter surface of the clamp 200. The clamp 200 is comprised of a lower half-moon clasp 201 and an upper half-moon clasp 203 which are joined using a puddle weld or the like that acts to securely fasten both halves of the clamp into a fixed position. In order to facilitate a puddle weld, a hole or aperture 215 may be drilled in one or both ends of the upper half-moon clasp 203 for allowing the weld material to more easily join both surfaces. Alternatively, a mechanical fastener such as a pressed in bolt or “Penn bolt” (not shown) may be used to join the lower half-moon clasp 201 and upper half-moon clasp around an exhaust pipe.

The lower half-moon clasp 201 is shown having collars 205, 207 welded to the outer surface of the lower half-moon clasp. The upper half-moon clasp includes collars 209, 211, and 213 that are fastened to its outer surface using a mechanical fastener or a weld joint. Each of the collars 205, 207, 209, 211, 213 utilizes a wire rope or cable 217 which is fastened within an interior portion of the swage button using a mechanical fastener 219 and/or a mechanical weld that acts to securely fasten the cable 217 within the respective swage button.

FIG. 3 illustrates an alternate embodiment of a clamp used with the catalytic converter theft deterrent device as shown in FIG. 2. In this embodiment, one or more collars 301 are used in connection with a wire rope or cable 303. A plurality of wires 305, 307 are used in combination with a continuity detection device 309 for detecting when electrical continuity is lost and/or interrupted between an audible sounding device, such as a siren or the vehicle's horn 311, and a vehicle's battery 313. In use, the negative side of the battery 313 is used in connection with wires 305, 307 where the vehicle horn would be isolated from the vehicle's ground. In operation, if continuity is lost in either of wires 305, 307, the continuity detector 309 detects the operates to actuate or “sound” the vehicle's horn 311 for deterring or scaring away would be thieves working to cut through the remainder of the cable 303. This system provides yet another option for preventing theft of the vehicles catalytic converter.

Thus, an embodiment of the present invention is a catalytic converter theft deterrent device that includes unique combination clamp fastener and wire rope cable that acts to substantially surround portions of an exhaust inlet and outlet pipe used directly adjacent to a vehicular catalytic converter. The theft deterrent device operates to obstruct a saw blade or other cutting mechanism from accessing portions of the exhaust pipe for preventing the catalytic converter from being removed from under a vehicle.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1 A catalytic converter theft deterrent assembly used with a motor vehicle comprising:
a plurality clamps for attaching to a section of exhaust pipe used with a catalytic converter;
a plurality of wire ropes fixedly attached to the plurality of clamps for surrounding portions around of the perimeter of the exhaust pipe;
a plurality of swage buttons fixedly attached to the plurality of clamps for housing an end portion of the plurality of cables; and
wherein the cables prevent removal of the exhaust pipe connected to the catalytic converter.

2. A catalytic converter theft deterrent assembly as in claim 1, wherein the clamps are positioned on both the inlet exhaust pipe to the catalytic converter and outlet exhaust pipe from the catalytic converter.

3. A catalytic converter theft deterrent assembly as in claim 2, wherein the wire ropes do not extend across the catalytic converter

4. A catalytic converter theft deterrent assembly as in claim 1, wherein the plurality of clamps each includes at least four collars.

5. A catalytic converter theft deterrent assembly as in claim 1, wherein the end portion of the wire ropes is fastened into the collars using a mechanical fastener that is fixed into position using a weld.

6. A catalytic converter theft deterrent assembly as in claim 1, wherein the clamp includes a lower half-moon clasp and an upper half-moon clasp that are joined tightly around the perimeter of the exhaust pipe.

7. A catalytic converter theft deterrent assembly as in claim 1, wherein one of the plurality of wire ropes includes an electrical wire embedded therein for triggering a sound device if continuity is lost in the electrical wire.

8. A catalytic converter theft deterrent assembly as in claim 1, wherein the electrical wire maintains a negative ground connection between the vehicle battery and a triggering relay.

9. A theft deterrent device for preventing theft of catalytic converter comprising:
a first clamp for attaching to an exhaust pipe having a plurality of collars attached about the perimeter of the first clamp;
a second clamp for attaching to a vehicle's exhaust pipe having a plurality of collars attached about the perimeter of the second clamp;
a plurality of wire ropes extending in parallel between the plurality of collars; and
wherein the first clamp and second clamp are poisoned on the exhaust pipe so the plurality of wire ropes are substantially taut for preventing portions of the exhaust pipes from being cut.

10. A theft deterrent device as in claim 9, further comprising:
a third clamp having a plurality of collars that is attached between the first clamp and second clamp for guiding the wire ropes over a span of exhaust pipe.

11. A theft deterrent device as in claim 9, wherein an end of each one of the plurality of wire ropes is fastened within one of the plurality of collars.

12. A theft deterrent device as in claim 9, wherein the exhaust pipe includes both an inlet pipe to the catalytic converter and an outlet pipe from the catalytic converter.

13. A theft deterrent device as in claim 12, wherein the wire ropes do not extend across the catalytic converter.

14. A theft deterrent device as in claim 9, wherein the plurality of clamps each include at least four collars.

15. A theft deterrent device as in claim 9, wherein an end portion of one of the plurality of wire ropes is fastened into a swage button using a mechanical fastener that is fixed into position using a weld.

16. A theft deterrent device as in claim 9, wherein the first clamp and second clamp both include a lower half-moon clasp and an upper half-moon clasp that are joined tightly around the perimeter of the exhaust pipe.

17. A theft deterrent device as in claim 9, wherein at least one of the plurality of wire ropes includes an electrical wire imbedded therein for triggering the vehicle's horn if continuity is lost in the electrical wire.

18. A theft deterrent device as in claim 9, wherein the electrical wire maintains a negative ground connection between the vehicle battery and a triggering relay.

19. A catalytic converter theft deterrent device comprising:
a first clamp having a plurality of collars;
a second clamp having a plurality of collars;
a third clamp having a plurality of collars positioned between the first clamp and second clamp;
a plurality of wire rope cables extending between the first clamp and the second clamp such that the plurality of collars act to align each of the plurality of wire rope cables in a substantially parallel fashion around the perimeter of an exhaust pipe; and
wherein the first clamp, second clamp, and third clamp include a lower half-moon clasp and an upper half-moon clasp that are joined tightly around the perimeter of the exhaust pipe and each positioned at either end of a vehicular catalytic converter.

20. A catalytic converter theft deterrent device as in claim 19, wherein an end of each one of the plurality of wire rope cables is fastened within one of the plurality of collars on the first clamp and second clamp.

21. A catalytic converter theft deterrent device as in claim 19, wherein the plurality of wire rope cables do not extend across the catalytic converter.

22. A catalytic converter theft deterrent device as in claim 19, wherein the plurality of clamps each include at least four collars.

23. A catalytic converter theft deterrent device as in claim 19, wherein an end portion of one of the plurality of wire rope cables is fastened into the plurality of collars on the first clamp and second clamp using a mechanical fastener that is fixed into position using a weld.

24. A catalytic converter theft deterrent device as in claim 19, wherein at least one of the plurality of wire rope cables includes an electrical wire imbedded therein for triggering a sounding device if continuity is lost in the electrical wire.

25. An theft deterrent device as in claim 19, wherein the electrical wire maintains a negative ground connection between the vehicle battery and a triggering relay.
